(19) United States
(12) Patent Application Publication
(10) Pub. No.: US 2007/0101848 A1
(43) Pub. Date: May 10, 2007

(54) Corner trimming device

(76) Inventor: Chun-Yuan Chang, Taichung (TW)

Correspondence Address: NIKOLAI & MERSEREAU, P.A., 900 SECOND AVENUE SOUTH, SUITE 820, MINNEAPOLIS, MN, 55402, US

(21) Appl. No.: 11/271,719

(22) Filed: Nov. 9, 2005

(51) Int. Cl. B26D 1/00

(52) U.S. Cl. 83/679

(57) ABSTRACT

A corner trimming device includes a base, a placement seat secured on the base, an anvil secured on the placement seat, a pivot seat pivotally mounted between the base and the placement seat, a trimming blade secured in the pivot seat to move therewith and movable relative to the anvil, and a restoring spring mounted between the base and the pivot seat to provide a restoring force to the pivot seat. Thus, the restoring spring and the elastic plate provide a restoring force to the pivot seat to restore the press portion and the trimming blade to the original state, thereby facilitating a user operating the press portion to trim the corner of the paper.

### BACKGROUND OF THE INVENTION

1. Field of the Invention

The present invention relates to a corner trimming device and, more particularly, to a corner trimming device for trimming corners of a sheet member, such as a sheet of paper.

2. Description of the Related Art

A corner trimming device is used to trim the corners of a sheet member, such as a sheet of paper, a name card, a photograph or the like. A conventional corner trimming device was disclosed in the U.S. Pat. No. 6,840,145B1 to Lee, filed on Jul. 8, 2003, entitled “DEVICE FOR TRIMMINING CORNER OR SHEET MEMBER”. In such a conventional corner trimming device, the blade is made of an elastic member so that the blade has an elastically restoring effect. However, the blade has a very small thickness to maintain the elasticity of the blade, thereby increasing difficulty in fabrication of the blade, and thereby increasing costs of fabrication. In addition, the blade is very thin, so that the blade is easily worn out or broken due to an excessive force. Further, the blade easily produces elastic fatigue during a long-term utilization, thereby affecting operation of the corner trimming device.

### SUMMARY OF THE INVENTION

In accordance with the present invention, there is provided a corner trimming device, comprising a base, a placement seat secured on the base, an anvil secured on the placement seat, a pivot seat pivotally mounted between the base and the placement seat, a trimming blade secured in the pivot seat to move therewith and movable relative to the anvil, and a restoring spring mounted between the base and the pivot seat to provide a restoring force to the pivot seat.

The primary objective of the present invention is to provide a corner trimming device having an automatically restored function.

Another objective of the present invention is to provide a corner trimming device, wherein the restoring spring and the elastic plate provide a restoring force to the pivot seat to restore the press portion and the trimming blade to the original state, thereby facilitating a user operating the press portion to trim the corner of the paper.

A further objective of the present invention is to provide a corner trimming device, wherein the restoring spring and the elastic plate provide a buffering effect to movement of the pivot seat, so that the trimming blade is moved slowly and stably so as to trim the corner of the paper smoothly.

A further objective of the present invention is to provide a corner trimming device, wherein the elastic plate is limited by the two limit plates of the base so as to limit the movement of the pivot seat, so that of the pivot seat and the trimming blade are moved uniformly without being inclined reclined sideward so as to trim the corner of the paper exactly.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a corner trimming device in accordance with the preferred embodiment of the present invention.

FIG. 2 is an exploded perspective view of the corner trimming device as shown in FIG. 1.

FIG. 3 is a plan cross-sectional view of the corner trimming device as shown in FIG. 1.

FIG. 4 is a schematic operational view of the corner trimming device as shown in FIG. 3.

### DETAILED DESCRIPTION OF THE INVENTION

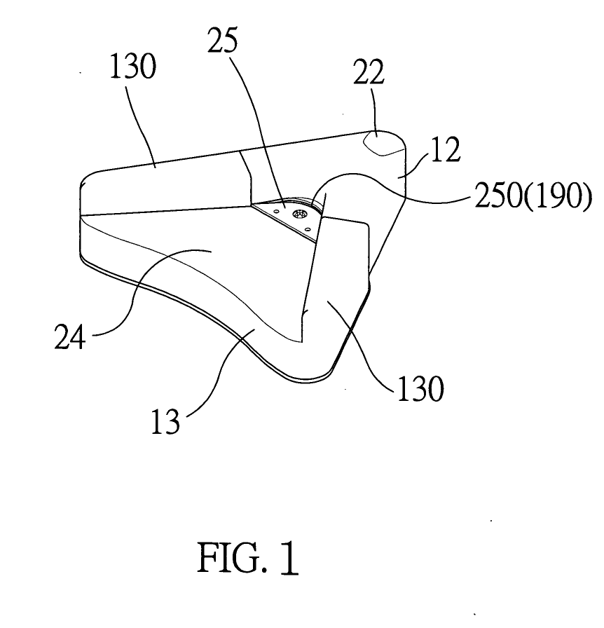

Referring to the drawings and initially to FIGS. 1-3, a corner trimming device in accordance with the preferred embodiment of the present invention comprises a base 11, a placement seat 13 secured on the base 11, an anvil 25 secured on the placement seat 13, a pivot seat 12 pivotally mounted between the base 11 and the placement seat 13, a trimming blade 19 secured in the pivot seat 12 to move therewith and movable relative to the anvil 25, and a restoring spring 18 mounted between the base 11 and the pivot seat 12 to provide a restoring force to the pivot seat 12. The trimming blade 19 is located at a height greater than that of the anvil 25 by the elastic force of the restoring spring 18.

The base 11 is substantially triangular. The base 11 is provided with a receiving portion 20 located under the anvil 25 and the trimming blade 19 to receive chips cut by the anvil 25 and the trimming blade 19. A bottom cap 16 is removably mounted on a bottom of the receiving portion 20 of the base 11. The base 11 is formed with a plurality of through holes 14. The base 11 has an end portion provided with a fixing post 17 and a mediate portion provided with two limit plates 21.

The placement seat 13 is secured on the base 11 by a plurality of locking bolts 15 which are extended through the through holes 14 of the base 11. The placement seat 13 has a platform 24. The placement seat 13 is substantially triangular and has two side walls 130 inclined relative to each other to form a substantially V-shaped profile. The platform 24 of the placement seat 13 is located between the two side walls 130.

A bent elastic plate 27 is mounted on a bottom of the placement seat 13 and has a first end located above and rested on the two limit plates 21 of the base 11. The first end of the elastic plate 27 is secured on the bottom of the placement seat 13 by a locking screw 28.

The anvil 25 is secured on a corner of the platform 24 of the placement seat 13 by a locking screw 26 and has a periphery formed with a convex cutting edge 250.

The pivot seat 12 has a first portion protruded outward from the placement seat 13 and provided with a press portion 22 that is movable relative to the base 11 and a second portion located between the base 11 and the placement seat 13 and provided with a resting bar 23 located above and rested on a second end of the elastic plate 27. The resting bar 23 of the pivot seat 12 is rotatable relative to the placement seat 13 by pressing the press portion 22 to press the second end of the elastic plate 27. The press portion 22 of the pivot seat 12 has an inside provided with a fixing post 220, and the restoring spring 18 is mounted between the fixing post 17 of the base 11 and the fixing post 220 of the pivot seat 12. The pivot seat 12 is substantially V-shaped and has two arms 120 inclined relative to each other, wherein first ends of the two arms 120 are connected to form the press portion 22, and the resting bar 23 is mounted between second ends of the two arms 120.

The two side walls 130 of the placement seat 13 encompass the two arms 120 of the pivot seat 12, and the resting bar 23 of the pivot seat 12 is located under the platform 24 of the placement seat 13.

The trimming blade 19 is secured in a mediate portion of the pivot seat 12 by a plurality of locking screws 29 and movable relative to the anvil 25 by pressing the press portion 22. The trimming blade 19 is substantially arc-shaped and has a periphery formed with a concave cutting edge 190 that is movable to contact the convex cutting edge 250 of the anvil 25.

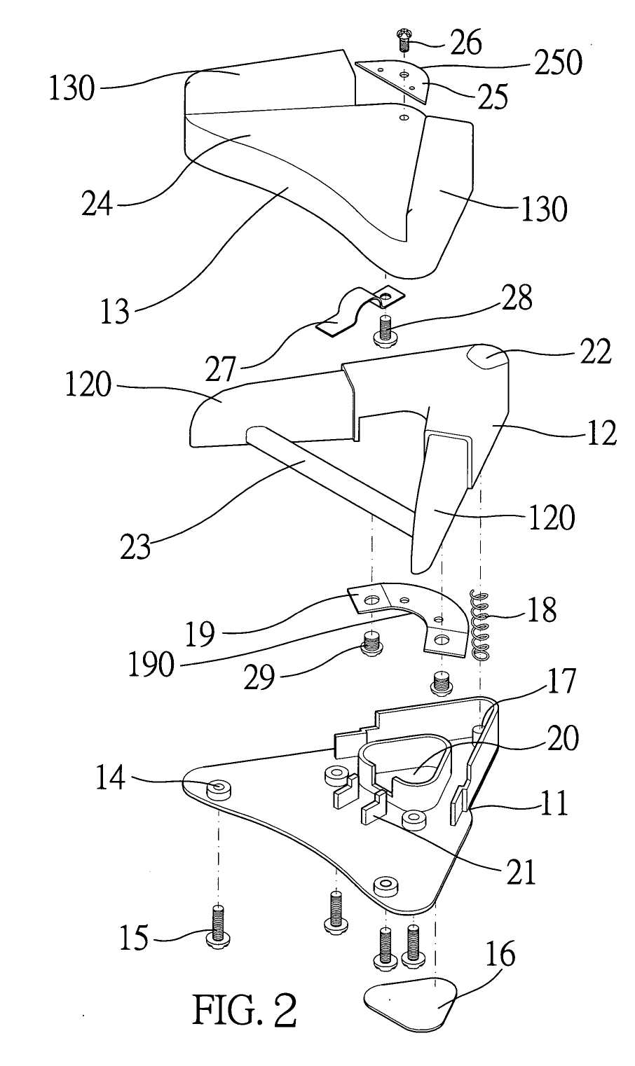

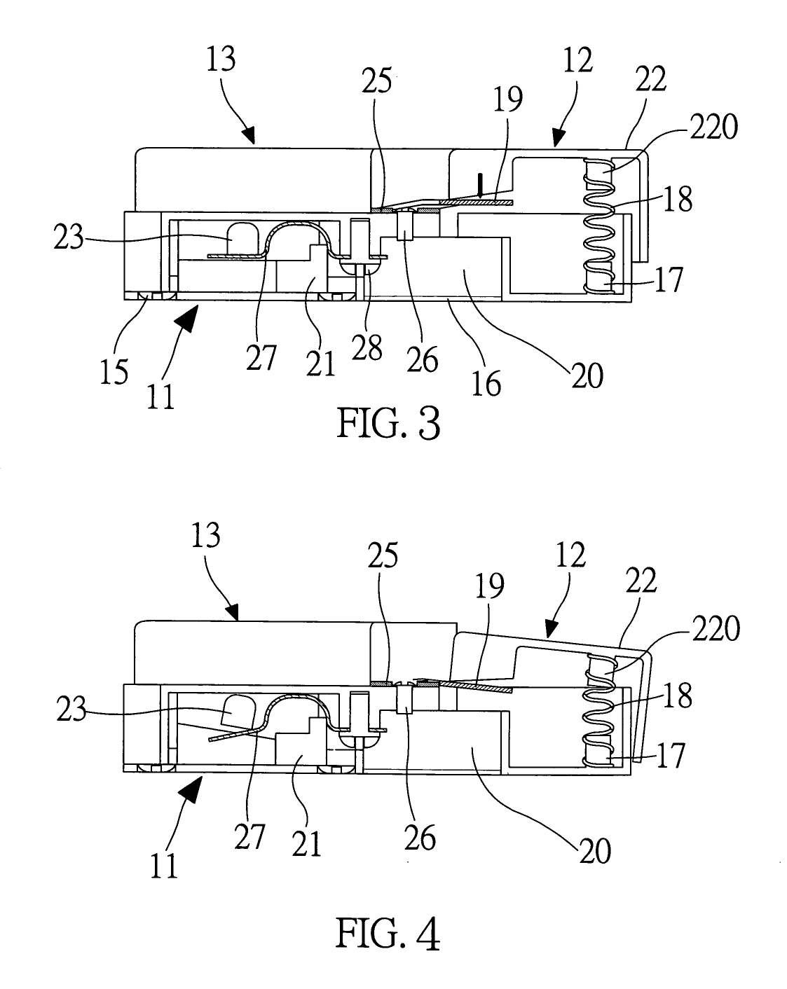

In operation, referring to FIGS. 3 and 4 with reference to FIGS. 1 and 2, when a sheet of paper (not shown) is placed on the platform 24 of the placement seat 13, the corner of the paper is located between the trimming blade 19 and the anvil 25. When the press portion 22 of the pivot seat 12 is pressed downward as shown in FIG. 4, the trimming blade 19 is movable downward relative to the anvil 25 so that the corner of the paper is cut by the concave cutting edge 190 of the trimming blade 19 and the convex cutting edge 250 of the anvil 25. Thus, the corner of the paper is trimmed to have a smooth shape.

At this time, when the press portion 22 of the pivot seat 12 is pressed downward, the resting bar 23 of the pivot seat 12 presses the second end of the elastic plate 27 which provides a buffering effect to movement of the pivot seat 12, so that the trimming blade 19 is moved smoothly and stably so as to trim the corner of the paper smoothly and exactly.

Accordingly, the restoring spring 18 and the elastic plate 27 provide a restoring force to the pivot seat 12 to restore the press portion 22 and the trimming blade 19 to the original state as shown in FIG. 3, thereby facilitating a user operating the press portion 22 to trim the corner of the paper. In addition, the restoring spring 18 and the elastic plate 27 provide a buffering effect to movement of the pivot seat 12, so that the trimming blade 19 is moved slowly and stably so as to trim the corner of the paper smoothly. Further, the elastic plate 27 is limited by the two limit plates 21 of the base 11 so as to limit the movement of the pivot seat 12, so that of the pivot seat 12 and the trimming blade 19 are moved uniformly without being inclined reclined sideward so as to trim the corner of the paper exactly.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A corner trimming device, comprising:
a base;
a placement seat secured on the base;
an anvil secured on the placement seat;
a pivot seat pivotally mounted between the base and the placement seat;
a trimming blade secured in the pivot seat to move therewith and movable relative to the anvil;
a restoring spring mounted between the base and the pivot seat to provide a restoring force to the pivot seat.

2. The corner trimming device in accordance with claim 1, wherein the trimming blade is located at a height greater than that of the anvil by the elastic force of the restoring spring.

3. The corner trimming device in accordance with claim 1, wherein the base is substantially triangular.

4. The corner trimming device in accordance with claim 1, wherein the base is provided with a receiving portion located under the anvil and the trimming blade.

5. The corner trimming device in accordance with claim 4, further comprising a bottom cap removably mounted on a bottom of the receiving portion of the base.

6. The corner trimming device in accordance with claim 1, wherein the base is formed with a plurality of through holes, and the placement seat is secured on the base by a plurality of locking bolts which are extended through the through holes of the base.

7. The corner trimming device in accordance with claim 1, wherein the base has an end portion provided with a fixing post, the press portion of the pivot seat has an inside provided with a fixing post, and the restoring spring is mounted between the fixing post of the base and the fixing post of the pivot seat.

8. The corner trimming device in accordance with claim 1, wherein the placement seat is substantially triangular.

9. The corner trimming device in accordance with claim 1, wherein the placement seat has a platform.

10. The corner trimming device in accordance with claim 9, wherein the placement seat has two side walls inclined relative to each other to form a substantially V-shaped profile.

11. The corner trimming device in accordance with claim 10, wherein the placement seat has a platform located between the two side walls.

12. The corner trimming device in accordance with claim 9, wherein the anvil is secured on a corner of the platform of the placement seat by a locking screw and has a periphery formed with a convex cutting edge, and the trimming blade is substantially arc-shaped and has a periphery formed with a concave cutting edge that is movable to contact the convex cutting edge of the anvil.

13. The corner trimming device in accordance with claim 1, wherein the pivot seat has a first portion protruded outward from the placement seat and provided with a press portion that is movable relative to the base and a second portion located between the base and the placement seat and provided with a resting bar rested on the elastic plate.

14. The corner trimming device in accordance with claim 13, wherein the base has a mediate portion provided with two limit plates, and the corner trimming device further comprises a bent elastic plate mounted on a bottom of the placement seat and having a first end located above and rested on the two limit plates of the base.

15. The corner trimming device in accordance with claim 14, wherein the resting bar of the pivot seat is located above and rested on a second end of the elastic plate.

16. The corner trimming device in accordance with claim 14, wherein the first end of the elastic plate is secured on the bottom of the placement seat by a locking screw.

17. The corner trimming device in accordance with claim 15, wherein the resting bar of the pivot seat is rotatable relative to the placement seat by pressing the press portion to press the second end of the elastic plate.

18. The corner trimming device in accordance with claim 13, wherein the pivot seat is substantially V-shaped and has two arms inclined relative to each other, wherein first ends of the two arms are connected to form the press portion, and the resting bar is mounted between second ends of the two arms.

19. The corner trimming device in accordance with claim 18, wherein the placement seat has two side walls inclined relative to each other to encompass the two arms of the pivot seat, and the resting bar of the pivot seat is located under the platform of the placement seat.

20. The corner trimming device in accordance with claim 13, wherein the trimming blade is secured in a mediate portion of the pivot seat by a plurality of locking screws and movable relative to the anvil by pressing the press portion.
